(19) United States
(12) Patent Application Publication
(10) Pub. No.: US 2015/0380012 A1
(43) Pub. Date: Dec. 31, 2015

(54) SPEECH REHABILITATION ASSISTANCE APPARATUS AND METHOD FOR CONTROLLING THE SAME

(71) Applicant: TERUMO KABUSHIKI KAISHA, Tokyo (JP)

(72) Inventors: Miyuki KOYAMA, Kawasaki-shi (JP); Toshihide TANAKA, Tokyo (JP); Tadashi SAMESHIMA, Isehara-shi (JP)

(73) Assignee: TERUMO KABUSHIKI KAISHA, Tokyo (JP)

(21) Appl. No.: 14/667,152

(22) Filed: Mar. 24, 2015

(30) Foreign Application Priority Data
Jun. 25, 2014 (JP) 2014-130657

(51) Int. Cl. G10L 25/48; G10L 15/08

(52) U.S. Cl. CPC G10L 25/48; G10L 15/08

(57) ABSTRACT

A speech rehabilitation assistance apparatus is disclosed, which can execute effective speech rehabilitation of, for example, a dysarthric speaker. The speech rehabilitation assistance apparatus can include a specification section specifying a target phoneme type and specifying at least one of a word head, a word middle, and a word end as a position of the specified phoneme type, a presentation section presenting a word selected from words having the specified phoneme type in the specified position, a voice recognition section recognizing a voice uttered when a trainee reads out the presented word, and a provision section providing an evaluation value concerning the voice uttered by the trainee based on history of a recognition result by the voice recognition section.

### CROSS-REFERENCES TO RELATED APPLICATIONS

This application claims priority to Japanese Application No. 2014-130657 filed on Jun. 25, 2014, the entire content of which is incorporated herein by reference.

### TECHNICAL FIELD

The present disclosure relates to a speech rehabilitation assistance apparatus and a control method thereof.

### BACKGROUND DISCUSSION

Dysarthria is one of speech deficits. It is considered that dysarthria occurs when at least one of articulatory movement elements (such as speech clarity, speech speed, and speech volume) is damaged. For dysarthric speakers, speech therapists have carried out speech rehabilitation intended for improvement of speech functions or substitution of other functions.

However, speech clarity is checked by speech therapists with their own ears while in conversation freely with patients. Therefore, it can be difficult for patients to know their speech clarity and perform exercises by setting the goal according to a clear index concerning speech clarity.

There is a known speech rehabilitation assistance apparatus that causes the patient to utter the word corresponding to, for example, pictures or characters indicated and recognizes the voice, thereby making an acceptance decision (see Japanese Patent No. 4048226).

However, an apparatus as disclosed in Japanese Patent No. 4048226 cannot easily grasp the effects of exercise. In addition, such an apparatus cannot perform exercises specific to sounds that cannot be pronounced correctly.

### SUMMARY

In accordance with exemplary embodiment, a speech rehabilitation assistance apparatus is disclosed, which can execute effective speech rehabilitation of, for example, a dysarthric speaker.

In accordance with an exemplary embodiment, a speech rehabilitation assistance apparatus is disclosed, which can include a specification section specifying a target phoneme type and specifying at least one of a word head, a word middle, and a word end as a position of the specified phoneme type, a presentation section presenting a word selected from words having the specified phoneme type in the specified position, a voice recognition section recognizing a voice uttered when a trainee reads out the presented word, and a provision section providing an evaluation value concerning the voice uttered by the trainee based on history of a recognition result by the voice recognition section.

In accordance with an exemplary embodiment, a method for controlling a speech rehabilitation assistance apparatus, the method comprising: specifying a target phoneme type and specifying at least one of a word head, a word middle, and a word end as a position of the specified phoneme type; presenting a word selected from words having the specified phoneme type in the specified position; recognizing a voice uttered when a trainee reads out the presented word; and providing an evaluation value concerning the voice uttered by the trainee based on history of a recognition result in the recognizing step.

In accordance with an exemplary embodiment, a non-transitory computer-readable recording medium with a program stored therein which causes a computer to function as sections of a speech rehabilitation assistance apparatus is disclosed, the sections of the computer-readable recording medium comprising: a specification section specifying a target phoneme type and specifying at least one of a word head, a word middle, and a word end as a position of the specified phoneme type; a presentation section presenting a word selected from words having the specified phoneme type in the specified position; a voice recognition section recognizing a voice uttered when a trainee reads out the presented word; and a provision section providing an evaluation value concerning the voice uttered by the trainee based on history of a recognition result by the voice recognition section.

### BRIEF DESCRIPTION OF THE DRAWINGS

FIG. 1 is a diagram illustrating the appearance structure of a robot according to an exemplary embodiment.

FIG. 2 is a block diagram illustrating the internal structure of the robot according to the exemplary embodiment.

FIG. 3 is a diagram showing an example of the module structure of a speech exercise program according to the exemplary embodiment.

FIG. 4 is a flowchart illustrating speech exercise processing according to the exemplary embodiment.

FIG. 5 is a diagram showing an example of a home screen for the speech exercise processing according to the exemplary embodiment.

FIG. 6 is a diagram showing an example of a menu screen for the speech exercise processing according to the exemplary embodiment.

FIG. 7 is a diagram showing an example of a word presentation screen for the speech exercise processing according to the exemplary embodiment.

FIG. 8 is a diagram showing an example of the word presentation screen for the speech exercise processing according to the exemplary embodiment.

FIG. 9 is a diagram showing an example of displaying an exercise evaluation result in the exemplary embodiment.

FIG. 10 is a diagram showing an example of displaying an exercise evaluation result in the exemplary embodiment.

### DETAILED DESCRIPTION

A preferred embodiment of the present disclosed will be described in detail with reference to the drawings. The disclosure is not limited to the following embodiment and the embodiment is only a specific example advantageous to achieve the disclosure. In addition, all combinations of features described in the following embodiment are not required to solve the problems of the invention.

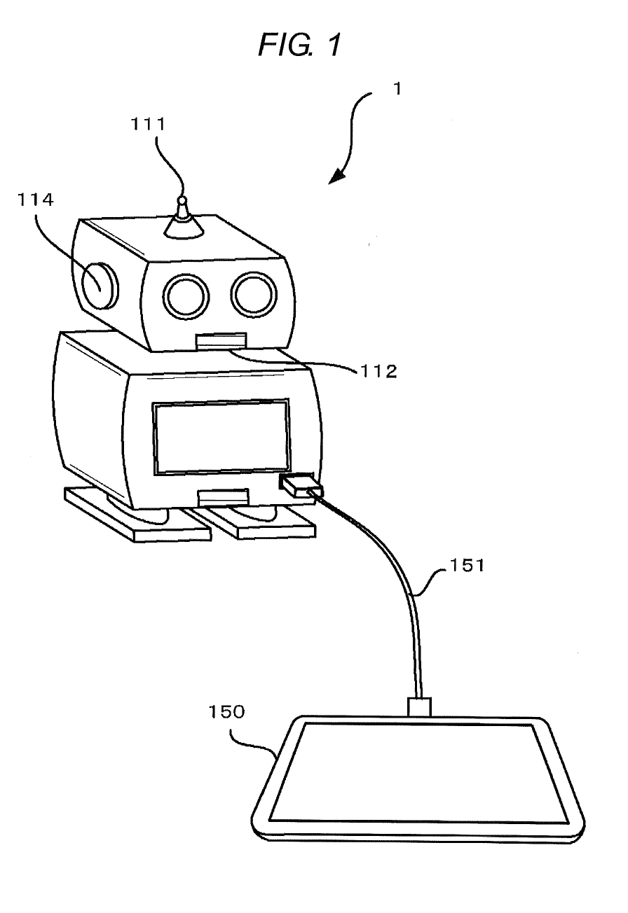

FIG. 1 is a diagram illustrating the appearance structure of a robot 1, which can be a speech rehabilitation assistance apparatus according to an exemplary embodiment. The robot 1 interacts with a patient (trainee) such as a dysarthric speaker and provides the patient with speech representation for speech rehabilitation.

The robot 1 may have the same appearance as a general computer apparatus. However, since the robot 1 executes rehabilitation while interacting with the patient, the robot 1 preferably has an appearance structure that gives relaxation and familiarity to the patient. The robot 1 has an antenna 111 used for, for example, wireless communication. In addition, the robot 1 has a microphone 114 and a speaker 112 in the positions corresponding to those of an ear and a mouth of a person. In addition, a tablet terminal 150, which is a touch panel type display/input device used by the speech therapist or patient, can be connected to the robot 1 via a cable 151. The touch panel of the tablet terminal 150 can detect tapping and swiping by a finger of the user. However, the robot 1 may have these functions of the tablet terminal 150 in advance.

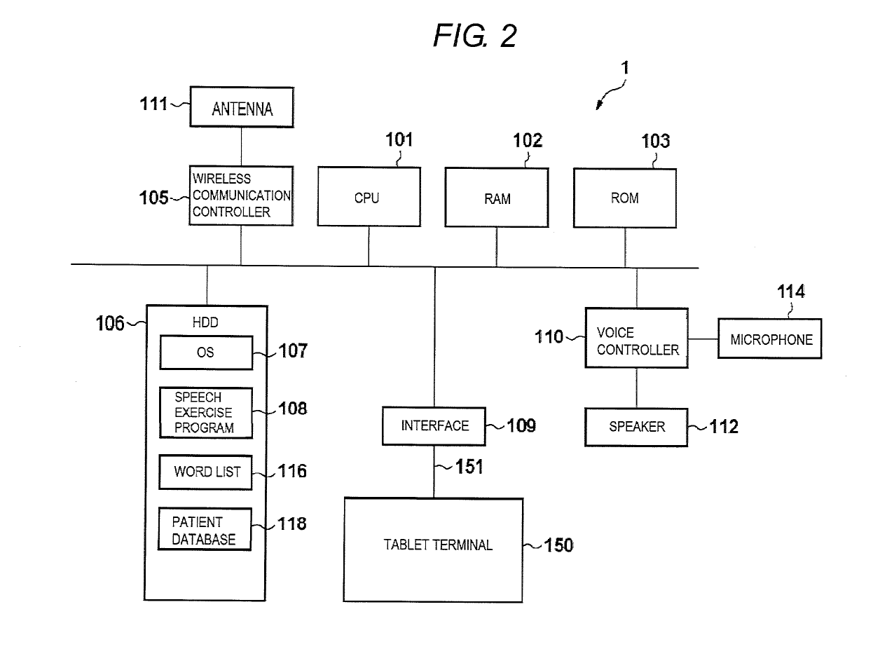

FIG. 2 is a block diagram illustrating the internal structure of the robot 1. The robot 1 can include a CPU 101 controlling the entire apparatus, a RAM 102 functioning as a main storage unit, a ROM 103 storing control programs and fixed data, and the following components, for example.

A wireless communication controller 105 controls wireless communication performed via the antenna 111. A HDD 106 is a hard disk device that stores an operating system (OS) 107, a speech exercise program 108, a word list 116 containing words used for exercises, and a patient database (DB) 118. An interface (I/F) 109 is used to connect the tablet terminal 150 via the cable 151. A voice controller 110, which includes an A/D converter (not illustrated), a D/A converter (not illustrated), an antialiasing filter (not illustrated), and so on, performs voice output using the speaker 112 and a voice input using the microphone 114.

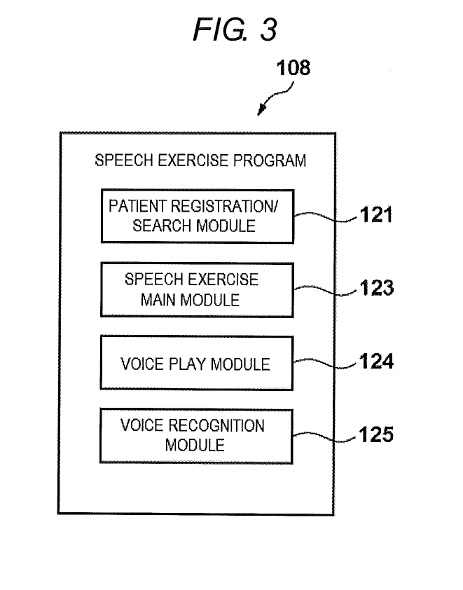

FIG. 3 shows an example of the module structure of the speech exercise program 108. A patient registration/search module 121 is a function module concerning processing for new registration in a patient DB 118 and processing for a search of the patient DB 118. The speech exercise main module 123 is responsible for execution of speech exercises. A voice play module 124 performs an acoustic output of a word in the word list 116. Voice synthesis (text synthesis) may be used for an acoustic output of a word in the word list 116. The voice play module 124 can also play recorded data of a patient. A voice recognition module 125 recognizes the speech of a patient. In this voice recognition module 125, voice recognition is performed using, for example, a word as the recognition unit. A model in which HMM (hidden Markov model) outputs a feature quantity according to GMM (Gaussian mixture model) in each state is used as an acoustic model. A word dictionary for voice recognition may be included in the voice recognition module 125 or may be independently stored in the HDD 106. However, the disclosure is not limited to a specific voice recognition algorithm.

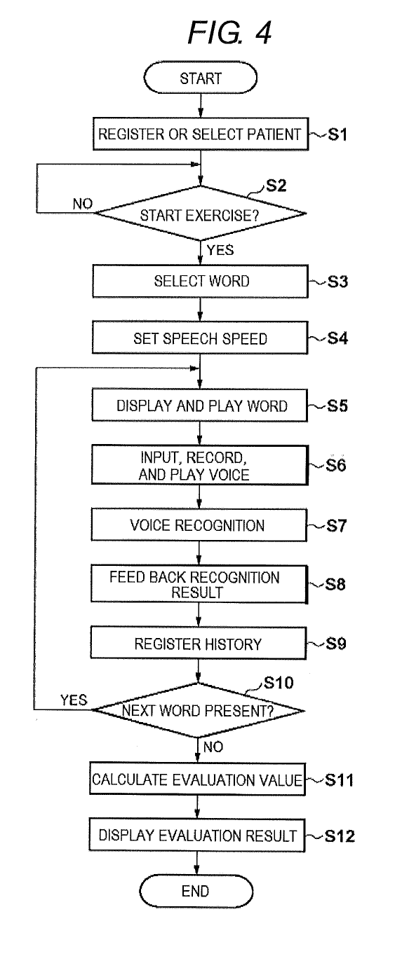

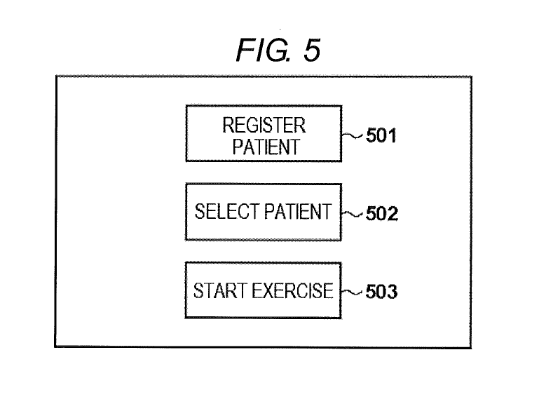

FIG. 4 is a flowchart illustrating speech exercise processing according to the embodiment. The program corresponding to this flowchart included in the speech exercise program 108 is loaded onto the RAM 102 and executed by the CPU 101. When this program is executed, a home screen as illustrated in FIG. 5 is first displayed in the tablet terminal 150. As illustrated in FIG. 5, the home screen includes a patient registration button 501, a patient selection button 502, and an exercise start button 503. When the user (for example, a speech therapist or a trainee) taps any of these buttons, a transition to the corresponding screen is performed.

When the patient registration button 501 or the patient selection button 502 is tapped (or pushed), a patient is registered or selected (S1). Since details on registration and selection of a patient are not directly related to the disclosure, examples of the screens are not illustrated. During registration, predetermined personal information such as a patient ID, name, and disability type is input. Upon completion of registration or selection, the home screen is displayed again.

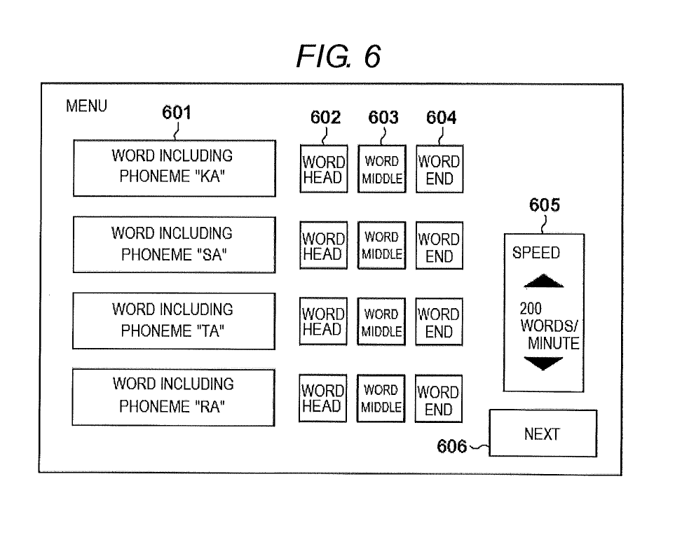

In S2, the processing waits for the exercise start button 503 to be tapped (or pushed). When the exercise start button 503 is tapped, the processing proceeds to a word selection step in S3. At this time, a menu screen as illustrated in FIG. 6 is displayed in the tablet terminal 150.

In FIG. 6, the user (speech therapist, patient, or patient helper) can select a target phoneme type (phoneme “KA”, “SA”, “TA”, or “RA” in the example in the drawing) from a button group 601. The user can further specify at least one of a word head 602, a word middle 603, and a word end 604 as the position of the target phoneme in a word.

In addition, in the present exemplary embodiment, the user can adjust the play speed of a word to be played in S4 (605), which can be because the play speed affects the understanding ratio of a patient and the articulation during imitation. When a NEXT button 606 is tapped (or pushed), the processing proceeds to S5.

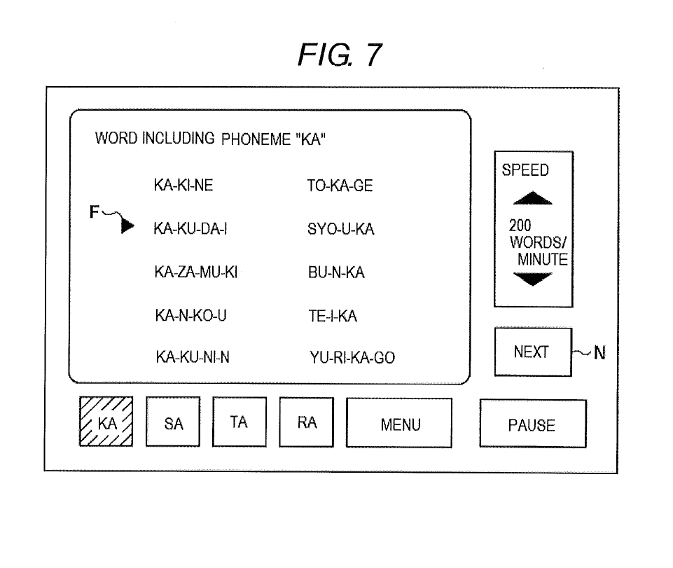

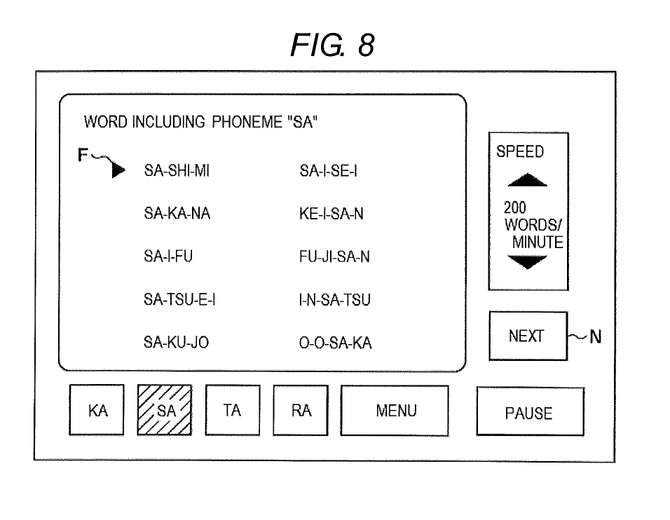

In S5, the words that meet the condition specified in S3 are selected from the word list 116 and a word presentation screen as illustrated in FIGS. 7 and 8 is displayed in the tablet terminal 150. FIG. 7 shows an example in which phoneme “KA” has been specified as a target in the menu screen in FIG. 6. FIG. 8 shows an example in which phoneme “SA” has been specified as a target in the menu screen in FIG. 6. The examples in FIGS. 7 and 8 assume that all of the word head, the word middle, and the word end are specified as the positions of the target phonemes. The word preceded by mark F is the current target word. The robot 1 announces, for example, “Repeat after me” and plays the target word at the play speed set in S4. It is noted that a sentence may be presented instead of a word and a meaningless word such as “NA DA NA DA NA DA” may be presented instead of a meaningful word.

The patient reads out the word, following the played word. The voice is input via the microphone 114 and recorded in, for example, the RAM 102 (S6). In the embodiment, the robot 1 may play and output the recorded voice immediately, which can help enable the patient to check his or her own utterance.

The robot 1 performs the voice recognition of the voice input in S6 (S7). The voice recognition is performed in the following manner, for example. First, the input voice is converted into a vector sequence of parameters such as LPC mel-cepstrum. Next, an acoustic model is applied to the parameter vectors to calculate the likelihood (phoneme similarity) for each phoneme. After that, the calculated phoneme similarity is compared with each of the words registered in the word dictionary to calculate the score (word likelihood) of each word. In the embodiment, for example, the maximum value of these word likelihoods is output as the recognition result.

Upon completion of voice recognition, the recognition result is fed back (S8). For example, when the maximum word likelihood output as the recognition result exceeds a predetermined threshold, the utterance is determined to be correct and the robot 1 presents the result with a synthetic voice stating “Good”, for example. In contrast, when the maximum word likelihood does not exceed a predetermined threshold, the robot 1 gives a response stating “Just one more effort,” for example. At this time, the recorded patient's speech may be played as feedback.

After that, the recognition result is registered as history (S9). At this time, the recognition result (word likelihood) is associated with execution date and time, target word, play speed, etc. when registered as history.

If an unprocessed target word remains (YES in S10) when a NEXT button N in FIG. 7 or 8 tapped (or pushed), the processing returns to S5 and performs the same processing on the next target word. When all target words are processed, the processing proceeds to S11.

In S11, the evaluation value can be calculated based on the collected history information. For example, when the speech exercise of a word including the target sound “KA” has been performed, the correct utterance ratio for each of the positions (word head, word middle, and word end) of the target sound “KA” and the correct utterance ratio for each of the play speeds of a presented word are calculated as evaluation values. In addition, the correct utterance ratio for each of exercise execution dates can also be calculated.

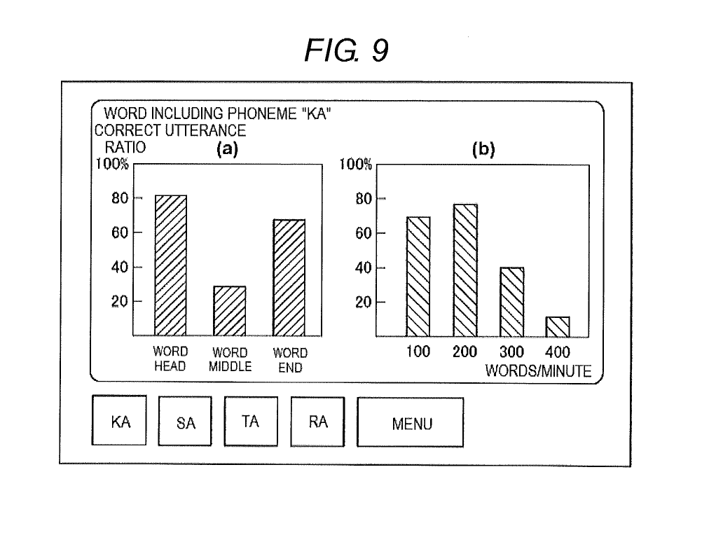

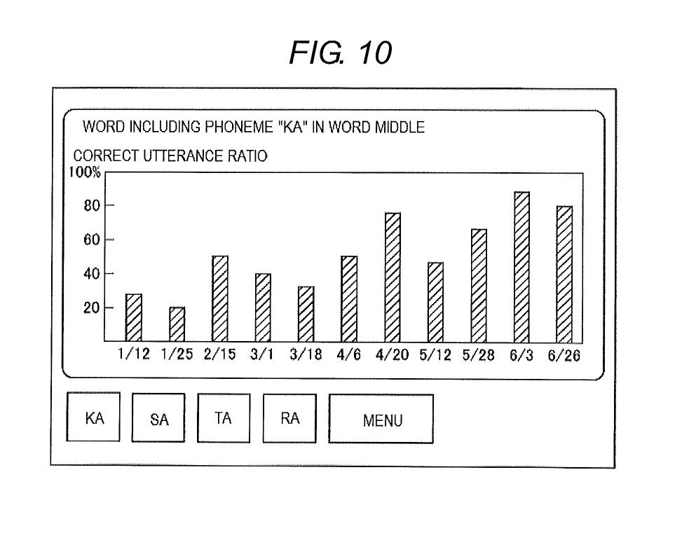

After that, the exercise evaluation results are displayed on the tablet terminal 150, for example (S12). Examples of indication are illustrated in FIGS. 9 and 10. Graph (a) in FIG. 9 illustrates the correct utterance ratio for each of the positions (word head, word middle, and word end) of the target sound “KA” and this graph is displayed when the speech exercise of a word including the target sound “KA” is performed. According to the graph, it is easy to determine whether pronunciation is correct for each of the positions of a particular phoneme. Graph (b) in FIG. 9 illustrates the correct utterance ratio for each of the play speeds of a presented word and this graph is displayed when the speech exercise of a word including the target sound “KA” is performed. FIG. 10 is a graph of the correct utterance ratio for each of the exercise execution dates. These indications allow the use to easily grasp the effects of exercises and perform exercises specific to target sounds that cannot be pronounced correctly, in the future. As a result, there is provided the speech rehabilitation assistance apparatus for advantageously executing effective speech rehabilitation of, for example, a dysarthric speaker.

In the above embodiment, the patient is provided with one word and prompted to read it. However, a plurality of words may be provided at a time and prompted to read them.

The detailed description above describes speech rehabilitation assistance apparatus and a control method thereof. The invention is not limited, however, to the precise embodiments and variations described. Various changes, modifications and equivalents can effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A speech rehabilitation assistance apparatus comprising:
a specification section specifying a target phoneme type and specifying at least one of a word head, a word middle, and a word end as a position of the specified phoneme type;
a presentation section presenting a word selected from words having the specified phoneme type in the specified position;
a voice recognition section recognizing a voice uttered when a trainee reads out a presented word; and
a provision section providing an evaluation value concerning the voice uttered by the trainee based on history of a recognition result by the voice recognition section.

2. The speech rehabilitation assistance apparatus according to claim 1,
wherein the presentation section has a play section playing the selected word.

3. The speech rehabilitation assistance apparatus according to claim 2, comprising:
an adjustment section adjusting a play speed of the selected word.

4. The speech rehabilitation assistance apparatus according to claim 1, comprising:
a section recording and playing the voice uttered when the trainee reads out the presented word.

5. The speech rehabilitation assistance apparatus according to claim 1,
wherein the evaluation value is a correct utterance ratio.

6. The speech rehabilitation assistance apparatus according to claim 5,
wherein the provision section displays the correct utterance ratio for each of the positions of the phonemes.

7. The speech rehabilitation assistance apparatus according to claim 5,
wherein the provision section displays the correct utterance ratio for each of the play speeds.

8. The speech rehabilitation assistance apparatus according to claim 5,
wherein the provision section displays the correct utterance ratio for each of exercise execution dates.

9. A method for controlling a speech rehabilitation assistance apparatus, the method comprising:
specifying a target phoneme type and specifying at least one of a word head, a word middle, and a word end as a position of the specified phoneme type;
presenting a word selected from words having the specified phoneme type in the specified position;
recognizing a voice uttered when a trainee reads out a presented word; and
providing an evaluation value concerning the voice uttered by the trainee based on history of a recognition result in the recognizing step.

10. A non-transitory computer-readable recording medium with a program stored therein which causes a computer to function as sections of a speech rehabilitation assistance apparatus, the sections of the computer-readable recording medium comprising:
a specification section specifying a target phoneme type and specifying at least one of a word head, a word middle, and a word end as a position of the specified phoneme type;
a presentation section presenting a word selected from words having the specified phoneme type in the specified position;
a voice recognition section recognizing a voice uttered when a trainee reads out a presented word; and
a provision section providing an evaluation value concerning the voice uttered by the trainee based on history of a recognition result by the voice recognition section.

11. The computer-readable recording medium according to claim 10,
wherein the presentation section has a play section playing the selected word.

12. The computer-readable recording medium according to claim 11, comprising:
an adjustment section adjusting a play speed of the selected word.

13. The computer-readable recording medium according to claim 10, comprising:
a section recording and playing the voice uttered when the trainee reads out the presented word.

14. The computer-readable recording medium according to claim 10,
wherein the evaluation value is a correct utterance ratio.

15. The computer-readable recording medium according to claim 14,
wherein the provision section displays the correct utterance ratio for each of the positions of the phonemes.

16. The computer-readable recording medium according to claim 14,
wherein the provision section displays the correct utterance ratio for each of the play speeds.

17. The computer-readable recording medium according to claim 14,
wherein the provision section displays the correct utterance ratio for each of exercise execution dates.
